(19) United States
(12) Patent Application Publication
(10) Pub. No.: US 2026/0068849 A1
(43) Pub. Date: Mar. 12, 2026

(54) MULTI-FOOD PET FEEDER

(71) Applicant: Shenzhen Petemeng Creative Technology Co., Ltd., Guangming District (CN)

(72) Inventor: Danyang WU, Shenzhen (CN)

(21) Appl. No.: 19/277,174

(22) Filed: Jul. 22, 2025

(30) Foreign Application Priority Data
Sep. 12, 2024 (CN) 2024112751861

(51) Int. Cl. A01K 5/02

(52) U.S. Cl. CPC A01K 5/0225

(57) ABSTRACT

A multi-food pet feeder is provided, including a first food storage warehouse, a second food storage warehouse, a first food leakage warehouse, a second food leakage warehouse, a food pushing warehouse, a second food outlet, and a food bowl. The first food leakage port is disposed at the bottom of the first food storage warehouse. The second food leakage port is disposed in the second food storage warehouse. The first food leakage warehouse is disposed below the first food storage warehouse. The second food leakage warehouse is disposed below the second food storage warehouse. The food pushing warehouse is rotatably disposed below the first food leakage warehouse or the second food leakage warehouse, and the food pushing warehouse includes a first food outlet disposed at the top of the food pushing warehouse. The second food outlet is disposed below the food pushing warehouse.

### TECHNICAL FIELD

The present disclosure relates to the field of pet feeding device technologies, and in particular, to a multi-food pet feeder.

### BACKGROUND

An automatic pet feeder is configured to automatically feed pet food into a food bowl so as to achieve a purpose of automatic feeding.

Pet feeders on the market usually have a trough or food bowl, and some have a plurality of food bowls, but only one type of pet food can only feed in these pet feeders at the same time, and a same type of pet food is distributed into different food bowls.

Pets eating the same type of pet food for a long time is not conducive to nutrition balance of the pets, which may affect appetite of the pets and cause anorexia of the pets, and then affects good health of the pets.

Therefore, it is necessary to design a multi-food pet feeder that can transport two types of pet food at the same time.

### SUMMARY

The present disclosure provides a multi-food pet feeder, and is intended to solve the above problem.

According to a first aspect of embodiments of the present disclosure, provided is a multi-food pet feeder, including:
a first food storage warehouse, where a first food leakage port is disposed at the bottom of the first food storage warehouse;
a second food storage warehouse, where a second food leakage port is disposed at the bottom of the second food storage warehouse;
a first food leakage warehouse, where the first food leakage warehouse is disposed below the first food storage warehouse, and is configured to store pet food fallen from the first food leakage port;
a second food leakage warehouse, where the second food leakage warehouse is disposed below the second food storage warehouse, and is configured to store pet food fallen from the second food leakage port;
a food pushing warehouse, where the food pushing warehouse is rotatably disposed below the first food leakage warehouse or the second food leakage warehouse, and the food pushing warehouse includes a first food outlet disposed at the top of the food pushing warehouse;
a second food outlet, where the second food outlet is disposed below the food pushing warehouse; and
a food bowl, where the food bowl is disposed below the second food outlet, and is configured to receive the pet food leaking from the second food outlet; where the food pushing warehouse rotates to a lower part of the first food leakage warehouse, the pet food in the first food leakage warehouse falls to the food pushing warehouse by using the first food outlet, the food pushing warehouse rotates to an upper part of the second food outlet, and the pet food in the food pushing warehouse falls to the food bowl by using the second food outlet; and
the food pushing warehouse moves to a lower part of the second food leakage warehouse, the pet food in the second food leakage warehouse falls to the food pushing warehouse by using the first food outlet, the food pushing warehouse moves to an upper part of the second food outlet, and the pet food in the food pushing warehouse falls to the food bowl by using the second food outlet.

In the multi-food pet feeder of the present disclosure, an upper housing, a lower housing, and a rotary disc are further included. The lower housing includes a cylindrical groove cavity. The cylindrical groove cavity is disposed toward the upper housing. A first annular convex wall portion is disposed at one end that is of the upper housing and that faces toward the lower housing. The rotary disc is rotatably disposed in the cylindrical groove cavity. The first annular convex wall portion is inserted into the cylindrical groove cavity and abuts against the rotary disc.

In the multi-food pet feeder of the present disclosure, the pet feeder further includes two first food blocking plates. The two first food blocking plates are fixedly disposed below the first food leakage port. The first food leakage warehouse is formed among the two first food blocking plates, the first annular convex wall portion, and the rotary disc.

In the multi-food pet feeder of the present disclosure, the pet feeder further includes two second food blocking plates. The two second food blocking plates are fixedly disposed below the second food leakage port. The second food leakage warehouse is formed among the two second food blocking plates, the second annular convex wall portion, and the rotary disc.

In the multi-food pet feeder of the present disclosure, the pet feeder further includes two third food blocking plates. The first food outlet is disposed in the rotary disc. The two third food blocking plates move synchronously with the rotary disc. The food pushing warehouse is formed by the two third food blocking plates, a bottom wall of the cylindrical groove cavity, and a side wall of the cylindrical groove cavity.

In the multi-food pet feeder of the present disclosure, the pet feeder further includes a motor, a first food poking plate, a second food poking plate, and a transmission component. The motor is in transmission connection with the first food poking plate and the second food poking plate by using the transmission component, and the motor is in transmission connection with the rotary disc. The first food poking plate is disposed in the first food storage warehouse. The second food poking plate is disposed in the second food storage warehouse.

In the multi-food pet feeder of the present disclosure, a second annular convex wall portion spaced apart from the first annular convex wall portion is further disposed on one side that is of the upper housing and that faces toward the cylindrical groove cavity, and the second annular convex wall portion is disposed inside the first annular convex wall portion. The pet feeder further includes a cover plate, and the cover plate covers the transmission component inside the second annular convex wall portion.

In the multi-food pet feeder of the present disclosure, the transmission component includes a first driving gear, a first transmission gear, and a second transmission gear. The motor is in transmission connected with the first driving gear. The first driving gear is in transmission connection with the first transmission gear and the second transmission gear.

In the multi-food pet feeder of the present disclosure, the transmission component includes a first transmission member and two second transmission members. The first transmission member includes a main shaft portion, a round table portion, and an eccentric shaft portion that are connected to each other. The main shaft portion and the eccentric shaft portion are disposed on two planes opposite to the round table portion. The main shaft portion is disposed at an axial position of the round table portion. The eccentric shaft portion is disposed away from an axis of the round table portion. The second transmission member includes a rotating shaft portion and a sliding rail plate portion that are connected to each other. A sliding chute portion is disposed on the sliding rail plate portion. One end of the rotating shaft portion of one of the second transmission members passes through the first food storage warehouse and penetrates into the first food poking plate, and one end of the rotating shaft portion of the other of the second transmission members passes through the second food storage warehouse and penetrates into the second food poking plate. The eccentric shaft portion passes through the sliding chute portion on the two sliding rail plates, so that when the first transmission member rotates, the first food poking plate and the second food poking plate swing around an axis of the rotating shaft portion.

In the multi-food pet feeder of the present disclosure, the pet feeder further includes a warehouse division plate. A cavity is disposed inside the upper housing. The warehouse division plate is disposed in the upper housing to divide the cavity in the upper housing into two parts and form the first food storage warehouse and the second food storage warehouse.

The technical solutions provided by the embodiments of this application may include the following beneficial effects. This application designs a multi-food pet feeder that may transport different types of pet food.

### BRIEF DESCRIPTION OF THE DRAWINGS

To describe the technical schemes in the embodiments of the present discourse more clearly, the following briefly describes the accompanying drawings required for describing the embodiments. Apparently, the accompanying drawings in the following descriptions show some embodiments of the present disclosure, and a person of ordinary skill in the art may derive others accompanying drawings from these accompanying drawings without creative efforts.

FIG. 1 is a schematic structural diagram of a pet feeder according to an embodiment of the present disclosure;

FIG. 2 is a schematic diagram of a cross-section structure of a pet feeder according to an embodiment of the present disclosure;

FIG. 3 is a schematic diagram of another cross-section structure of a pet feeder according to an embodiment of the present disclosure;

FIG. 4 is a part of an exploded schematic structural diagram of a pet feeder at a visual angle according to an embodiment of the present disclosure;

FIG. 5 is a part of an exploded schematic structural diagram of a pet feeder at another visual angle according to an embodiment of the present disclosure;

FIG. 6 is a part of a schematic structural diagram of a transmission component of a feeder at a visual angle according to an embodiment of the present disclosure;

FIG. 7 is a part of a schematic structural diagram of a transmission component of a feeder at another visual angle according to an embodiment of the present disclosure;

FIG. 8 is a partial schematic structural diagram of a feeder according to an embodiment in FIG. 6;

FIG. 9 is a part of a schematic structural diagram of a transmission component of a feeder at a visual angle according to another embodiment of the present disclosure;

FIG. 10 is a partial schematic structural diagram of a feeder according to an embodiment of the present disclosure;

FIG. 11 is an exploded schematic structural diagram of a feeder according to an embodiment of the present disclosure in FIG. 7; and

FIG. 12 is a schematic structural diagram of a connecting shaft of a feeder according to an embodiment of the present disclosure.

### REFERENCE SIGNS

10: first food storage warehouse; 11: first food leakage port; 20: second food storage warehouse; 21: second food leakage port; 30: first food leakage warehouse; 40: second food leakage warehouse; 50: food pushing warehouse; 51: first food outlet; 60: second food outlet; 70: food bowl; 80: upper housing; 81: first annular convex wall portion; 82: second annular convex wall portion; 90: lower housing; 91: cylindrical groove cavity; 100: rotary disc; 101: flat plate portion; 102: center ring portion; 110: first food blocking plate; 120: second food blocking plate; 130: third food blocking plate; 140: motor; 150: first food poking plate; 160: second food poking plate; 170: transmission component; 171: first driving gear; 172: first transmission gear; 173: second transmission gear; 174: first transmission member; 1741: main shaft portion; 1742: round table portion; 1743: eccentric shaft portion; 175: second transmission member; 1751: rotating shaft portion; 1752: sliding rail plate portion; 1753: sliding chute portion; 180: warehouse division plate; 190: cover plate; 200: connecting shaft; 201: mounting plate portion; 2011: bulge portion; 202: tooth portion; 203: transmission shaft portion; 210: touch switch; 2101: spring plate; 220: leg column; 230: chute plate; and 2301: food guiding chute.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are some rather than all of the embodiments of the present disclosure. Based on the embodiment in the present disclosure, all other embodiments acquired by the ordinary technical staff in the art under the premise of without contributing creative labor belong to the scope protected by the present disclosure.

It also should be understood that the terms used in the specification of the present disclosure are merely intended to describe specific embodiments but not intended to constitute any limitation on the present disclosure. As used in the specification of the present disclosure and the appended claims, singular forms of “a”, “an” and “the” are intended to include plural forms unless the context clearly indicates other situations.

The term “and/or” used in this specification of the present disclosure and the appended claims means any combination and all possible combinations of one or more of the associated listed items, and includes such combinations.

Pets on the market usually have only one food storage warehouse, and only one type of pet food can be fed into a food bowl at the same time. Therefore, a pet can only eat one type of pet food for a long time. In practice, mixing two different types of pet food into a same food storage warehouse for a long time may cause that the two types of pet food may be mixed and tainted by other order when being stored in the same closed food storage warehouse, which may accelerate deterioration of the pet food and affect appetite and good health of the pet. Therefore, in this application, two food storage warehouses are designed, and different pet food may be respectively fed into food bowls for pets to eat in different periods of time. For example, the pet eats the pet food in one food storage storehouse in the morning, and eats the pet food in another food storage storehouse in the evening. Certainly, the pet can eat the pet food in the two food storage warehouses at the same time. Specifically, the pet food can be set based on preference of a customer.

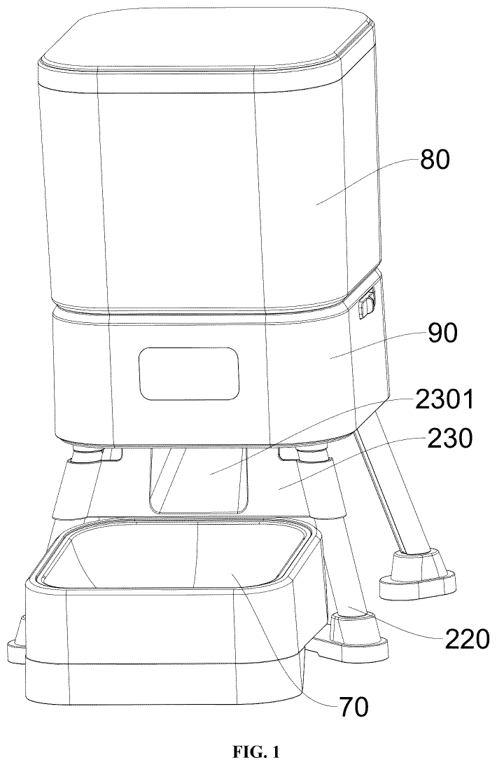

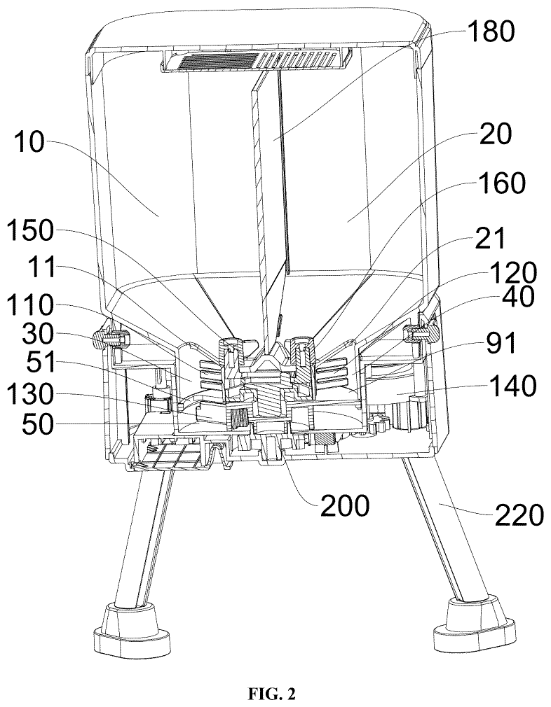

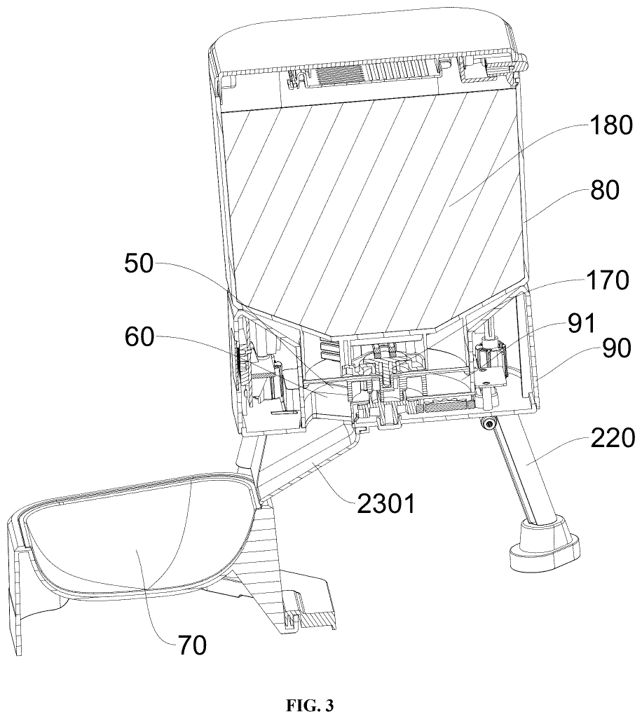

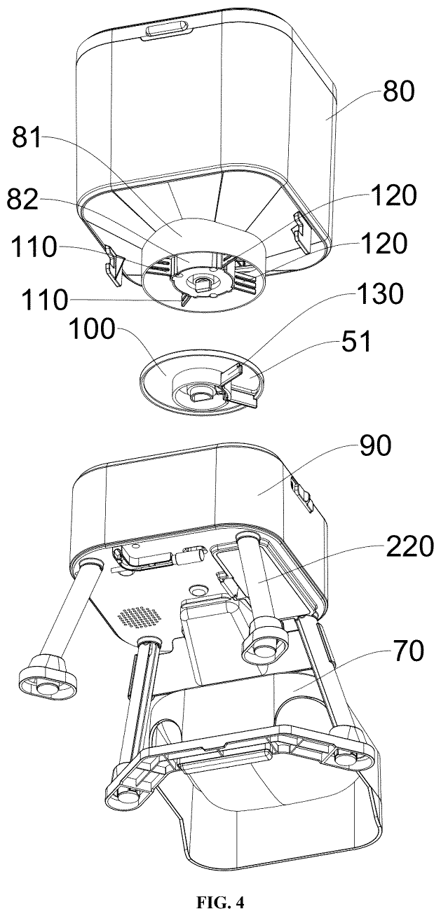

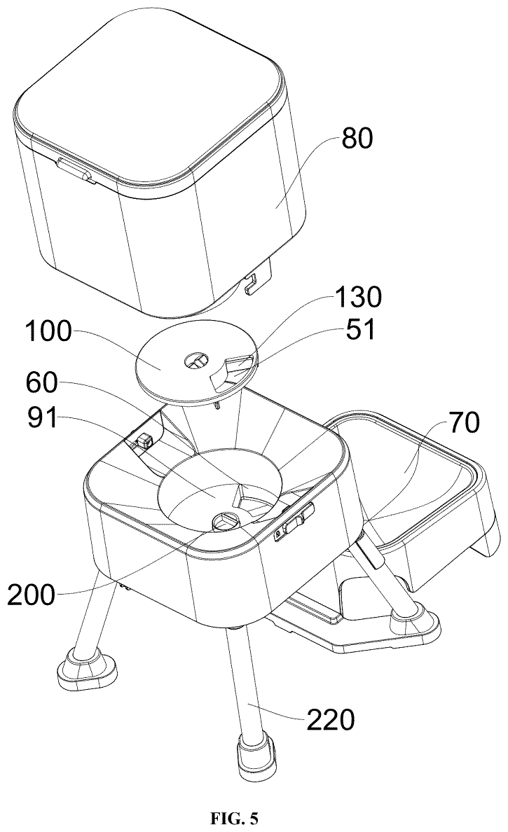

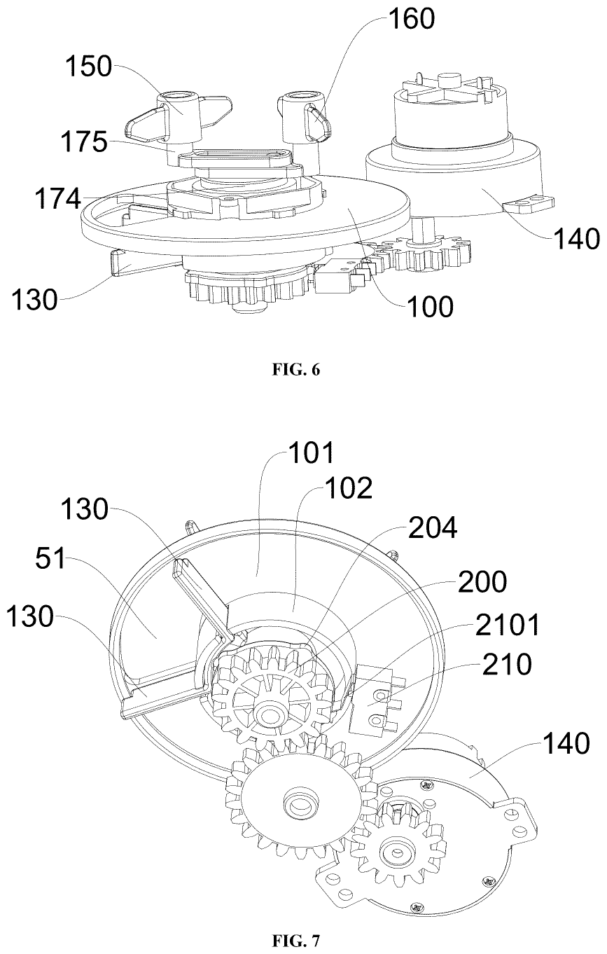

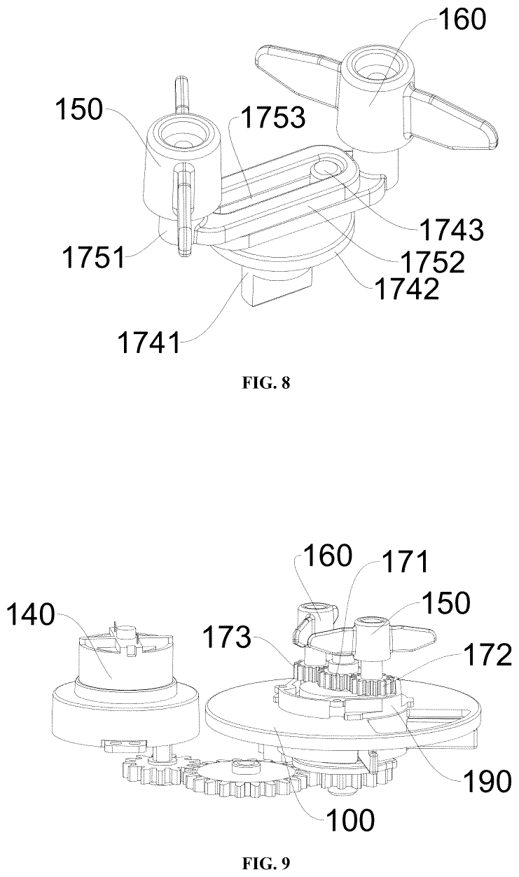

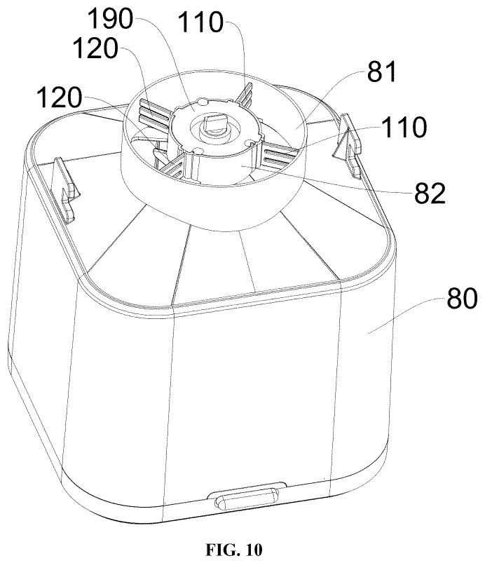

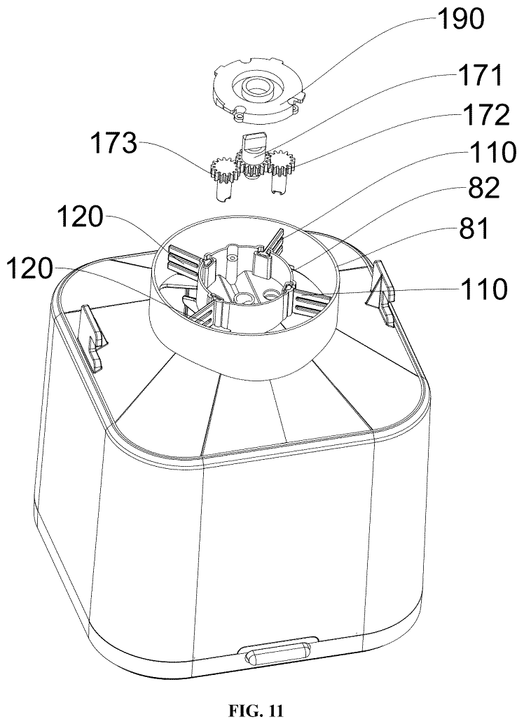

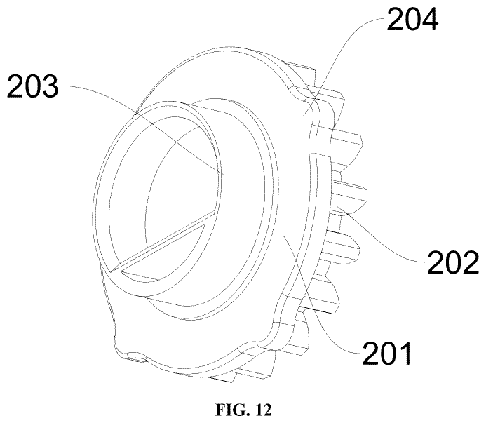

Referring to FIG. 1 to FIG. 12, the present disclosure discloses a multi-food pet feeder. The multi-food pet feeder includes a first food storage warehouse 10, a second food storage warehouse 20, a first food leakage warehouse 30, a second food leakage warehouse 40, a food pushing warehouse 50, a second food outlet 60, and a food bowl 70. A first food leakage port 11 is disposed at the bottom of the first food storage warehouse 10, so that pet food in the first food storage warehouse 10 may leak from the first food leakage port 11. A second food leakage port 21 is disposed at the bottom of the second food storage warehouse 20, so that pet food in the second food storage warehouse 20 may leak from the second food leakage port 21. The first food leakage warehouse 30 is disposed below the first food storage warehouse 10, and is configured to store pet food fallen from the first food leakage port 11. The second food leakage warehouse 40 is disposed below the second food storage warehouse 20, and is configured to store pet food fallen from the second food leakage port 21. The food pushing warehouse 50 is rotatably disposed below the first food leakage warehouse 30 or the second food leakage warehouse 40. The food pushing warehouse 50 includes a first food outlet 51. The first food outlet 51 is disposed at the top of the food pushing warehouse 50, and is configured to receive the pet food leaking from the first food leakage warehouse 30 or the second food leakage warehouse 40. The second food outlet 60 is disposed below the food pushing warehouse 50, and is configured to feed the pet food inside the food pushing warehouse 50 into the food bowl 70 when fallen out. The food bowl 70 is disposed below the second food outlet 60, and is configured to receive the pet food leaking from second food outlet 60.

In this embodiment, different types of pet food may be stored in the first food storage warehouse 10 and the second food storage warehouse 20 for the pet to eat. The food pushing warehouse 50 is rotatably disposed. When the pet food inside the first food storage warehouse 10 is needed, the food pushing warehouse 50 rotates to a lower part of the first food storage warehouse 30, the pet food inside the first food storage warehouse 30 falls to the food pushing warehouse 50 by using the first food outlet 51, and then the food pushing warehouse 50 rotates again to an upper part of a position of the second food outlet 60, so that the pet food inside the food pushing warehouse 50 can be fallen from the second food outlet 60. When the pet food inside the second food storage warehouse 20 is needed, the food pushing warehouse 50 rotates to a lower part of the second food storage warehouse 40, the pet food inside the second food storage warehouse 40 is fallen into the food pushing warehouse 50 by using the first food outlet 51, and then the food pushing warehouse 50 rotates again to the position of the second food outlet 60, so that the pet food inside the food pushing warehouse 50 can be fallen from the second food outlet 60, and then the pet food is fed into the food bowl 70. Two food storage warehouses are disposed in this application, and may store different types of pet food. In addition, different types of pet food can be fed into the food bowl 70 for use by the pet.

In an optional embodiment, the pet feeder in this application further includes an upper housing 80, a lower housing 90, and a rotary disc 100. The first food storage warehouse 10 and the second food storage warehouse 20 are disposed in the upper housing 80. The lower housing 90 includes a cylindrical groove cavity 91, and the cylindrical groove cavity 91 is disposed toward the upper housing 80. That is, the cylindrical groove cavity 91 is disposed in an upper part of the lower housing 90. A first annular convex wall portion 81 is disposed at one end that is of the upper housing 80 and that faces toward the lower housing 90, and an outer diameter of the first annular convex wall portion 81 is adapted to a diameter of the cylindrical groove cavity 91. The rotary disc 100 is rotatably disposed in the cylindrical groove cavity 91. An upper cavity is formed between the rotary disc 100 and a bottom wall of the cylindrical groove cavity 91. An upper cavity is formed between the rotary disc 100 and the first annular convex wall portion 81 and between the rotary disc 100 and the upper housing 80. The first food leakage warehouse 30 and the second food leakage warehouse 40 are disposed in the upper cavity. The food pushing warehouse 50 is disposed in the lower cavity.

In an optional embodiment, the pet feeder further includes two first food blocking plates 110, two second food blocking plates 120, and two third food blocking plates 130. The two first food blocking plates 110 are fixedly disposed below the first food leakage port 110. The first food leakage warehouse 30 is formed among the two first food blocking plates 110, the first annular convex wall portion 81, and the rotary disc 100. The two second food blocking plates 120 are fixedly disposed below the second food leakage port 21. The second food leakage warehouse 40 is formed among the two second food blocking plates 120, the first annular convex wall portion 81, and the rotary disc 100. The two third food blocking plates 130 rotate synchronously with the rotary disc 100, and the food pushing warehouse 50 is formed among the two third food blocking plates 130, the bottom wall of the cylindrical groove cavity 91, and a side wall of the cylindrical groove cavity 91.

Specifically, the upper housing 80 further includes a second annular convex wall portion 82. The second annular convex wall portion 82 and the first annular convex wall portion 81 are disposed coaxially. The first annular convex wall portion 81 is disposed on an outer side of the second annular convex wall portion 82. The first food blocking plate 110 and the second food blocking plate 120 are both fixedly mounted on the second annular convex wall portion 82. Positions of the two first food blocking plates 110 are adapted to the first food leakage port 11, and positions of the two second food blocking plates 120 are adapted to the second food leakage port 21. In this embodiment, the first food leakage port 11 and the second food leakage port 21 are both in a sector shape. The first food blocking plate 110 and the second food blocking plate 120 both extend from the second annular convex wall portion 82 to the first annular convex wall portion 81. The two first food blocking plates 110 are disposed on an outer side of an edge of the first food leakage port 11, that is, projection of the first food leakage port 11 on the rotary disc 100 is less than a size between the two first food blocking plates 110, so that the pet food fallen from the first food leakage port 11 may completely fall between the two first food blocking plates 110 (that is, inside the first food leakage warehouse 30). Similarly, a principle of the second food blocking plate 120 is similar to that of the first food blocking plate 110. The two second food blocking plates 120 are disposed on an outer side of an edge of the second food leakage port 21, so that the pet food fallen from the second food leakage port 21 can completely fall into the second food leakage warehouse 40.

The rotary disc 100 includes a flat plate portion 101 and a center ring portion 102. The center ring portion 102 is disposed at a central position of the flat plate portion 101. The center ring portion 102 extends from a central position of the flat plate portion 101 to the bottom wall of the cylindrical groove cavity 91, and abuts against the bottom wall of the cylindrical groove cavity 91, so that the stable lower cavity may be formed between the flat plate portion 101 and the bottom wall of the cylindrical groove cavity 91. The flat plate portion 101 abuts against the first annular convex wall portion 81. In this embodiment, the first food outlet 51 is disposed in the flat plate portion 101, the third food blocking plate 130 is fastened to the rotary disc 100, and the third food blocking plate 130 extends from the center ring portion 102 to the side wall of the cylindrical groove cavity 91. The rotary disc 100 is rotatably disposed. In addition, a food pushing warehouse 50 is formed among the flat plate portion 101, the two second food blocking plates 120, and the bottom wall of the cylindrical groove cavity 91. Therefore, the food pushing warehouse 50 in this application may rotate with the rotary disc 100, and a position of the food pushing warehouse 50 may change. For example, when the food pushing warehouse 50 moves to the lower part of the second food leakage warehouse 40 during moving from a lower part of the first food leakage warehouse 30 to a lower part of the second food leakage warehouse 40, the pet food in the second food leakage warehouse 40 falls from the first food leakage warehouse 51 to the food pushing warehouse 50, and subsequently, the food pushing warehouse 50 moves to the second food outlet 60 and then leaks from the second food outlet 60. In this embodiment, the second food outlet 60 is disposed in the bottom wall of the cylindrical groove cavity 91.

In some optional embodiments, the first food blocking plates 110, the second food blocking plates 120, and the third food blocking plates 130 are all of a flexible glue material. The first food blocking plates 110, the second food blocking plates 120, and the third food blocking plates 130 are all set to be of a flexible glue material, so that when the rotary disc 100 rotates, a case that food is stuck is avoided.

In an optional embodiment, the pet feeder further includes a motor 140, a first food poking plate 150, a second food poking plate 160, and a transmission component 170. The motor 140 is in transmission connection with the first food poking plate 150 and the second food poking plate 160 by using the transmission component 170, and the motor 140 is in transmission connection with the rotary disc 100. The first food poking plate 150 is disposed in the first food storage warehouse 10, and the second food poking plate 160 is disposed in the second food storage warehouse 20. In this application, the first food poking plate 150 and the second food poking plate 160 may be driven to swing or rotate by using one motor 140, so as to poke the pet food inside the first food storage warehouse 10 and the second food storage warehouse 20 into the first food leakage warehouse 30 and the second food leakage warehouse 40 and avoid the pet food from being stuck in the first food storage warehouse 10 and the second food storage warehouse 20. In addition, the two food poking plates may be driven to swing or rotate by using one motor 140, and the rotary disc 100 may alternatively be driven to rotate, so that a structure is simple, and a volume of the entire pet feeder is simplified.

In an optional embodiment, the pet feeder in this application further includes a warehouse division plate 180. The warehouse division plate 180 is disposed in the upper housing 80. The warehouse division plate 180 is disposed at a middle position inside the upper housing 80, so as to divide space inside the upper housing 80 into two parts and form the first food storage warehouse 10 and the second food storage warehouse 20.

In an optional embodiment, the pet feeder further includes a cover plate 190, and the cover plate 190 is disposed on the second annular convex wall portion 82 in a covering manner, so as to seal the transmission component 170 therein. By setting the cover plate 190, it is convenient for a user to clean the inside later. When in use, the user can directly take out the upper housing 80, so that it is convenient for the user to operate.

In an optional embodiment, the transmission component 170 includes a first driving gear 171, a first transmission gear 172, and a second transmission gear 173. The motor 140 is in transmission connected with the first driving gear 171. The first driving gear 171 is in transmission connection with the first transmission gear 172 and the second transmission gear 173.

In this embodiment, the motor 140 is disposed in the lower housing 90, and the motor 140 rotates to drive the first driving gear 171 to rotate (specifically, the motor 140 may drive the first driving gear 171 by using some gear pairs). The first driving gear 171 rotates to drive the first transmission gear 172 and the second transmission gear 173 to rotate, thereby driving the first food poking plate 150 and the second food poking plate 160 to rotate, so as to poke the pet food inside the first food storage warehouse 10 and the second food storage warehouse 20.

In this embodiment, a spacing between the first food poking plate 150 and the second food poking plate 160 is less than a sum of radii of the first food poking plate 150 and the second food poking plate 160. This structure is to not increase an external size of the upper housing 80, so that the external size of the upper housing 80 in this application is relatively small, so as to reduce a volume of this device. It should be noted that, to reduce the external size of the upper housing 80, the first food poking plate 150 and the second food poking plate 160 do not rotate in a completely whole circle, but swings within a specific angle range, so as to avoid from touching the warehouse division plate 180 in the upper housing 80.

In another optional embodiment, the transmission component 170 includes a first transmission member 174 and two second transmission members 175. The motor 140 is in transmission connection with the first transmission member 174 and the second transmission member 175. The motor 140 drives the first transmission member 174 to rotate. The first transmission member 174 then drives the second transmission member 175 to move. The second transmission member 175 drives the first food poking plate 150 and the second food poking plate 160 to swing back and forth at a certain angle, so as to poke the pet food inside the first food storage warehouse 10 and the second food storage warehouse 20.

The first transmission member 174 includes a main shaft portion 1741, a round table portion 1742, and an eccentric shaft portion 1743 that are connected to each other. The main shaft portion 1741 and the eccentric shaft portion 1743 are disposed on two planes opposite to the round table portion 1742. The main shaft portion 1741 is disposed at an axial position of the round table portion 1742. The eccentric shaft portion 1743 is disposed away from an axis of the round table portion 1742. The second transmission member 175 includes a rotating shaft portion 1751 and a sliding rail plate portion 1752 that are connected to each other. The rotating shaft portion 1751 is disposed at one end of the sliding rail plate portion 1752. A sliding chute portion 1753 is disposed on the sliding rail plate portion 1752. One end of one of the rotating shaft portions 1751 passes through the first food storage warehouse 10. The first food poking plate 150 is sleeved on the rotating shaft portion 1751. One end of the other of the rotating shaft portions 1751 of the second transmission member 175 passes through the second food storage warehouse 20. The second food poking plate 160 is sleeved on the rotating shaft portion 1751. The eccentric shaft portion 1743 passes through the sliding chute portion 1753 on the two sliding rail plates. The eccentric shaft portion 1743 is a shaft that deviates from the axis. When the main shaft portion 1741 rotates, the eccentric shaft portion 1743 rotates around the axis of the main shaft portion 1741. In addition, in a rotating process, the eccentric shaft portion 1743 may slide in the sliding chute portion 1753. Therefore, the eccentric shaft portion 1743 may drive the rotating shaft portion 1751 to swing at a certain angle, and the rotating shaft portion 1751 moves synchronously with the first food poking plate 150 and the second food poking plate 160. Therefore, the first food poking plate 150 and the second food poking plate 160 may alternatively swing at a certain angle. Thus, the pet food inside the first food storage warehouse 10 and the second food storage warehouse 20 is poked back and forth in limited space, so as to ensure that the pet food can fall smoothly into the first food leakage warehouse 30 and the second food leakage warehouse 40 without interfering with the warehouse partition plate 180 inside the upper housing 80, thereby reducing the size of the upper housing 80 to reduce the volume of the pet feeder. It should be noted that swinging angles of the first food poking plate 150 and the second food poking plate 160 are related to an eccentric size of the eccentric shaft portion 1743, and may be specifically set based on an actual requirement.

In an optional embodiment, the pet feeder further includes a connecting shaft 200. The connecting shaft 200 is in normal running fit with the rotary disc 100 synchronously, and the connecting shaft 200 is in transmission fit with the transmission component 170. The connecting shaft 200 includes a mounting plate portion 201, a tooth portion 202, and a transmission shaft portion 203 that are integrally formed. The tooth portion 202 and the transmission shaft portion 203 are disposed on two surfaces opposite to the mounting plate portion 201. The transmission shaft portion 203 is disposed in the cylindrical groove cavity 91. The tooth portion 202 is disposed in the lower housing 90, and the tooth portion 202 is in transmission connection with the motor 140. The connecting shaft 200 is driven to rotate by using the motor 140 so as to drive the first driving gear 171 to rotate, thereby driving the first food poking plate 150 and the second food poking plate 160 to swing.

The pet feeder further includes a touch switch 210, and three bulge portions 2011 are disposed on the mounting plate 201. The touch switch 210 has a spring plate 2101. In a rotating process of the connecting shaft 200, the three bulge portions 2011 abut against the spring plate 2101. The connecting shaft 200 and the rotary disc 100 move synchronously, and the first food outlet 51 is disposed on the rotary disc 100. Therefore, the three bulge portions are disposed on the mounting plate of the connecting shaft 200, and the three bulge portions are respectively corresponding to different positions of the first food outlet 51. Therefore, the position of the first food outlet 51 may be confirmed by using each of the three bulge portions to abut against the spring plate 2101. In this apparatus, a reset operation is performed during initial operation. That is, the reset operation is performed when the three bulge portions abut against the spring plate 2101, so as to determine whether the position of the food pushing warehouse 50 is correct in the rotating process.

It should be noted that, in this application, the upper housing 80, the rotary disc 100, and the lower housing 90 may be detachable. A key hole may be disposed in the transmission shaft portion 203 of the connecting shaft 200, and a bulge portion that is adapted to the key hole may be disposed on the rotary disc 100, so as to ensure that the upper housing 80, the rotary disc 100, and the lower housing 90 can be assembled at original positions after being detached. Specifically, the first food poking plate 150, the second food poking plate 160, the first food poking plate 110, and the second food poking plate 120 are all mounted on the upper housing 80. The rotary disc 100 and the third food blocking plate 130 are mounted together. A connecting portion is mounted in the lower housing 90, and the second transmission portion of the connecting portion stretches out of the cylindrical groove cavity 91 of the lower housing 90.

The pet feeder of this application further includes four leg columns 220 and a chute plate 230. The four leg columns 220 are respectively disposed at positions of four corner below the lower housing 90 to support the lower housing 90. The chute plate 230 is mounted on the leg column 220. The chute plate 230 includes a food guiding chute 2301. The food guiding chute 2301 is configured to guide the pet food fallen from the second food outlet 60 into the food bowl 70. The food bowl 70 is disposed below the chute plate 230, so that there is a height difference between the second food outlet 60 and the food bowl 70, so that the pet food can slide into the food bowl 70.

The foregoing descriptions are merely specific embodiments of the present disclosure, but are not intended to limit the protection scope of the present disclosure. Any modification or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A multi-food pet feeder, comprising:
a first food storage warehouse, wherein a first food leakage port is disposed at the bottom of the first food storage warehouse;
a second food storage warehouse, wherein a second food leakage port is disposed at the bottom of the second food storage warehouse;
a first food leakage warehouse, wherein the first food leakage warehouse is disposed below the first food storage warehouse, and is configured to store pet food fallen from the first food leakage port;
a second food leakage warehouse, wherein the second food leakage warehouse is disposed below the second food storage warehouse, and is configured to store pet food fallen from the second food leakage port;
a food pushing warehouse, wherein the food pushing warehouse is rotatably disposed below the first food leakage warehouse or the second food leakage warehouse, and the food pushing warehouse comprises a first food outlet disposed at the top of the food pushing warehouse;
a second food outlet, wherein the second food outlet is disposed below the food pushing warehouse; and
a food bowl, wherein the food bowl is disposed below the second food outlet, and is configured to receive the pet food leaking from the second food outlet; wherein
the food pushing warehouse rotates to a lower part of the first food leakage warehouse, the pet food in the first food leakage warehouse falls to the food pushing warehouse by using the first food outlet, the food pushing warehouse rotates to an upper part of the second food outlet, and the pet food in the food pushing warehouse falls to the food bowl by using the second food outlet; and
the food pushing warehouse moves to a lower part of the second food leakage warehouse, the pet food in the second food leakage warehouse falls to the food pushing warehouse by using the first food outlet, the food pushing warehouse moves to an upper part of the second food outlet, and the pet food in the food pushing warehouse falls to the food bowl by using the second food outlet.

2. The multi-food pet feeder according to claim 1, further comprising an upper housing, a lower housing, and a rotary disc, wherein the lower housing comprises a cylindrical groove cavity, the cylindrical groove cavity is disposed toward the upper housing, a first annular convex wall portion is disposed at one end that is of the upper housing and that faces toward the lower housing, the rotary disc is rotatably disposed in the cylindrical groove cavity, and the first annular convex wall portion is inserted into the cylindrical groove cavity and abuts against the rotary disc.

3. The multi-food pet feeder according to claim 2, wherein the pet feeder further comprises two first food blocking plates, the two first food blocking plates are fixedly disposed below the first food leakage port, and the first food leakage warehouse is formed among the two first food blocking plates, the first annular convex wall portion, and the rotary disc.

4. The multi-food pet feeder according to claim 3, wherein the pet feeder further comprises two second food blocking plates, the two second food blocking plates are fixedly disposed below the second food leakage port, and the second food leakage warehouse is formed among the two second food blocking plates, the second annular convex wall portion, and the rotary disc.

5. The multi-food pet feeder according to claim 2, further comprising two third food blocking plates, the first food outlet is disposed in the rotary disc, the two third food blocking plates move synchronously with the rotary disc, and the food pushing warehouse is formed by the two third food blocking plates, a bottom wall of the cylindrical groove cavity, and a side wall of the cylindrical groove cavity.

6. The multi-food pet feeder according to claim 4, further comprising a motor, a first food poking plate, a second food poking plate, and a transmission component, wherein the motor is in transmission connection with the first food poking plate and the second food poking plate by using the transmission component, the motor is in transmission connection with the rotary disc, the first food poking plate is disposed in the first food storage warehouse, and the second food poking plate is disposed in the second food storage warehouse.

7. The multi-food pet feeder according to claim 6, wherein a second annular convex wall portion spaced apart from the first annular convex wall portion is further disposed on one side that is of the upper housing and that faces toward the cylindrical groove cavity, and the second annular convex wall portion is disposed inside the first annular convex wall portion; and the pet feeder further comprises a cover plate, and the cover plate covers the transmission component inside the second annular convex wall portion.

8. The multi-food pet feeder according to claim 6, wherein the transmission component comprises a first driving gear, a first transmission gear, and a second transmission gear, the motor is in transmission connected with the first driving gear, and the first driving gear is in transmission connection with the first transmission gear and the second transmission gear.

9. The multi-food pet feeder according to claim 6, wherein the transmission component comprises a first transmission member and two second transmission members, the first transmission member comprises a main shaft portion, a round table portion, and an eccentric shaft portion that are connected to each other, the main shaft portion and the eccentric shaft portion are disposed on two planes opposite to the round table portion, the main shaft portion is disposed at an axial position of the round table portion, and the eccentric shaft portion is disposed away from an axis of the round table portion; the second transmission member comprises a rotating shaft portion and a sliding rail plate portion that are connected to each other, and a sliding chute portion is disposed on the sliding rail plate portion, one end of the rotating shaft portion of one of the second transmission members passes through the first food storage warehouse and penetrates into the first food poking plate, and one end of the rotating shaft portion of the other of the second transmission members passes through the second food storage warehouse and penetrates into the second food poking plate; and the eccentric shaft portion passes through the sliding chute portion on the two sliding rail plates, so that when the first transmission member rotates, the first food poking plate and the second food poking plate swing around an axis of the rotating shaft portion.

10. The multi-food pet feeder according to claim 2, further comprising a warehouse division plate, wherein a cavity is disposed inside the upper housing, and the warehouse division plate is disposed in the upper housing to divide the cavity in the upper housing into two parts and form the first food storage warehouse and the second food storage warehouse.
